(19) United States
(12) Patent Application Publication
(10) Pub. No.: US 2013/0125927 A1
(43) Pub. Date: May 23, 2013

(54) Agent for Cleaning a Container Configured for Making a Nutritional Shake and a Method of Using the Agent

(71) Applicant: Zachary Long, 29 Palms, CA (US)

(72) Inventor: Zachary Long, 29 Palms, CA (US)

(21) Appl. No.: 13/302,665

(22) Filed: Nov. 22, 2011

(51) Int. Cl. B08B 9/08; C11D 17/00; C11D 17/06

(52) U.S. Cl. 134/22.1; 510/218

(57) ABSTRACT

An agent for cleaning a container configured for making a nutritional shake and a method of using the agent is presented. The agent comprises a packaging unit being configured for containing at least one quantity of a mixture for cleaning the container. A mixture is configured to be dissolvable in water. The dissolved mixture is operable for substantially removing residue from the container in which the container is left substantially absent of aftertaste.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to nutritional supplements. More particularly, the invention relates to means of cleaning containers for making nutritional shakes.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Nutritional shakes such as, but not limited to, protein shakes are often prepared in a shaker. In this process a supplement powder, for example, without limitation, whey powder, is typically placed in the shaker with a liquid such as, but not limited to, water or milk. Then, the shaker is agitated until the powder is incorporated into the liquid. The preparation of nutritional shakes in shakers may result in a dirty, foul smelling shaker. One can also expect that an improperly cleaned shaker may become contaminated by germs.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flowchart illustrating an exemplary process for using a cleansing powder, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A practical embodiment of the present invention provides a solution that cleans protein shakers of residue, germs and odors. Shakers that are used to make protein shakes often become dirty and foul smelling. Many practical embodiments provide a powder that is added to water in a shaker to cleanse the shaker. Some alternate embodiments may be implemented to clean other types of shakers such as, but not limited to, shakers for various different types of nutritional shakes, powdered drink mix shakers, cocktail shakers, etc. Moreover, some alternate embodiments may be implemented to clean items other than shakers including, without limitation, reusable bottles for water and other drinks, food storage containers, blenders, etc. In many practical embodiments, the cleanser may be provided in premeasured packets, which may be convenient for on the go use, or in a tub for bulk storage.

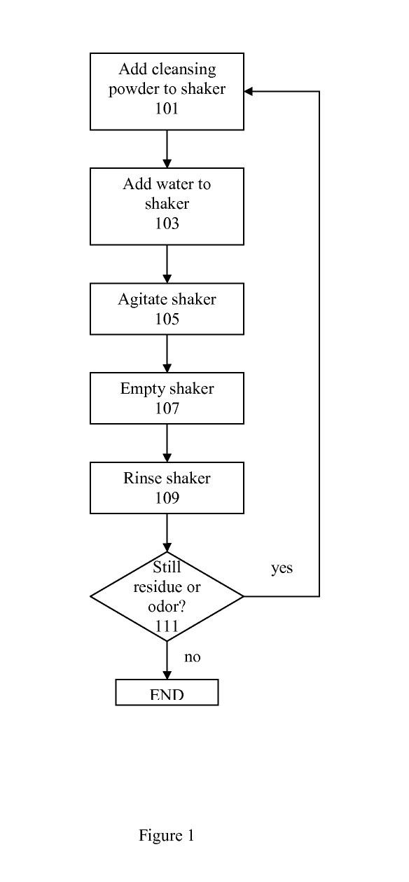

FIG. 1 is a flowchart illustrating an exemplary process for using a cleansing powder, in accordance with an embodiment of the present invention. In the present embodiment, after a user uses a shaker to make a protein shake or another type of shake, the user adds some of the cleansing powder to the shaker in step 101. If the powder is in a premeasured packet, the user opens the packet and pours it into the shaker. Packets may be desirable if the user would like to use the cleansing powder outside of the home, for example, without limitation, at the gym immediately after a workout or at work. If the powder is in bulk storage, the user may scoop or spoon the powder into the shaker. In step 103, the user adds water to the shaker. Alternatively, the user may reverse the order of steps 101 and 103 by adding water to the shaker then adding the cleansing powder to the shaker. In step 105, the user agitates the shaker to clean the shaker of residue, germs and odors. The user empties the shaker in step 107 and rinses the shaker with fresh water in step 109. In some alternate embodiments, the powder may be formulated so that rinsing after cleansing is not necessary. In the present embodiment, if the shaker still has residue or an odor in step 111, the user may return to step 101 to repeat the process. If the shaker does not need to be cleaned again, the process ends.

A cleansing powder according to the present embodiment is fast and easy to use and generally leaves no watery soap aftertaste. Shakers that are cleaned by the cleansing powder are typically germ free, odor free and sanitary. Thoroughly cleaning a shaker typically enables the shaker to be used repeatedly and for an extended time so that a user generally does not waste shakers by discarding shakers that are dirty and/or foul smelling. The cleansing powder may be used with virtually any type or size of shaker.

In some alternate embodiments, the cleanser may be implemented as a pre-mixed solution rather than a powder. Those skilled in the art will readily recognize, in light of and in accordance with the teachings of the present invention, that cleansers in some alternate embodiments may be implemented in a multiplicity of suitable forms such as, but not limited to, as dissolvable tablets, dissolving capsules, gels, sprays, foams, etc. Furthermore, it is contemplated that cleansers in accordance with some alternate embodiments may be used to clean various different types of containers and devices including, without limitation, reusable bottles, blenders, glasses, etc. and that the process of cleaning these items may vary from the process described in the foregoing. For example, without limitation, when cleaning a glass, a user may stir the cleanser into water, or, when cleaning a blender, a user may add the cleanser and water to the blender and turn the blender on. In some instances a user may wish to use a brush or sponge along with the cleanser when cleaning an item.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing a cleanser according to the present invention will be apparent to those skilled in the art. The invention has been described above by way of illustration, and the specific embodiments disclosed are not intended to limit the invention to the particular forms disclosed. For example, the particular implementation of the storage means may vary depending upon the particular type of cleanser used. The storage means described in the foregoing were directed to packet and tub implementations; however, similar techniques are to provided cleansers in various different storage means such as, but not limited to, canisters, bottles, capsules, tubes, aerosol cans, etc Implementations of the present invention provided in various different storage means are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An agent for cleaning a container configured for making a nutritional shake, the agent comprising:
a packaging unit being configured for containing at least one quantity of a mixture for cleaning the container; and
a mixture being configured to be dissolvable in water, the dissolved mixture being operable for substantially removing residue from the container in which the container is left substantially absent of aftertaste.

2. The agent as recited in claim 1, in which the dissolved mixture is further operable for substantially removing germs from the container.

3. The agent as recited in claim 1, in which the dissolved mixture is further operable for substantially removing odors from the container.

4. The agent as recited in claim 1, in which the mixture comprises a powder.

5. The agent as recited in claim 4, in which the mixture further comprises the powder in a tablet or a capsule form.

6. The agent as recited in claim 1, in which the container comprises a shaker being configured for mixing a protein shake.

7. The agent as recited in claim 1, in which the packaging unit comprises a packet for containing one quantity of the mixture for cleaning one container.

8. A method of using the agent of claim 1, the method comprising the steps of:
combining the mixture and a quantity of water in the container;
agitating the dissolved mixture in the container; and
emptying the container to substantially remove residue, germs and odors from the container in which the container is left substantially absent of aftertaste.

9. The method as recited in claim 8, further comprising the step of rinsing the container.

10. The method as recited in claim 8, further comprising the step of removing the mixture from the packaging unit in which the packaging unit comprises a packet.

11. The method as recited in claim 8, in which the mixture comprises powder in a tablet or a capsule form.

12. The method as recited in claim 8, in which the step of agitating comprises shaking the container.

13. An agent for cleaning a shaker configured for making a protein shake, the agent comprising:
a packaging unit being configured for containing at least one quantity of a mixture for cleaning the shaker; and
a mixture comprising a powder and being configured to be dissolvable in water, the dissolved mixture being operable for substantially removing residue from the shaker, substantially removing germs from the shaker, and substantially removing odors from the shaker in which the shaker is left substantially absent of aftertaste.

14. The agent as recited in claim 13, in which the mixture comprises a tablet or a capsule form.

15. The agent as recited in claim 13, in which the packaging unit comprises a packet for containing one quantity of the mixture for cleaning one shaker.
